(19) United States
(12) Patent Application Publication
(10) Pub. No.: US 2018/0242243 A1
(43) Pub. Date: Aug. 23, 2018

(54) USER DEVICE, NETWORK NODE, METHOD AND COMPUTER PROGRAM PRODUCT

(71) Applicant: Huawei Technologies Co., Ltd., Shenzhen (CN)

(72) Inventor: Petteri KELA, Helsinki (FI)

(73) Assignee: Huawei Technologies Co., Ltd., Shenzhen (CN)

(21) Appl. No.: 15/957,278

(22) Filed: Apr. 19, 2018

Related U.S. Application Data
(63) Continuation of application No. PCT/EP2015/074171, filed on Oct. 19, 2015.

(51) Int. Cl. H04W 52/02; H04B 7/0417; H04L 5/00; H04W 72/04

(52) U.S. Cl. CPC H04W 52/0216; H04B 7/0417; H04B 7/0626; H04W 72/0413; H04L 5/0051

(57) ABSTRACT

A user device for a wireless communication system comprises a processor, configured to determine an on-duration period of an activity cycle, check that a channel state information (CSI) is valid, and monitor a down link control channel only while the CSI is valid and the user device is in the on-duration period of the activity cycle. A network node comprises a processor; and a transceiver; wherein the processor is configured to determine an on-duration period of an activity cycle, wherein the transceiver is configured to receive CSI updates, and wherein the processor further is configured to check that the CSI is valid, and to transmit data on a down link control channel only while the CSI is valid and the processor is in the on-duration period of the activity cycle.

### CROSS-REFERENCE TO RELATED APPLICATIONS

This application is a continuation of International Application No. PCT/EP2015/074171, filed on Oct. 19, 2015, the disclosure of which is hereby incorporated by reference in its entirety.

### TECHNICAL FIELD

The embodiments of the present invention relates to a user device for a radio network and to a network node for a radio network. Furthermore, the embodiments of the present invention also relate to corresponding methods, a computer program, and a computer program product.

### BACKGROUND

In wireless networks utilizing massive antenna arrays and multi-user (MIMO; Multiple Input Multiple Output) transmission techniques there is a problem in that there are not always enough resources for obtaining enough up-to-date Channel State Information (CSI) from all active users. Hence, this is a major drawback of massive MIMO systems, since they require a large fraction of the frame radio resources to be allocated for pilot resources to achieve high spectral efficiency. This is a well-known challenge of massive MIMO systems causing pilot pollution or pilot contamination problems in neighboring network nodes due to lack of orthogonal pilot resources.

Further to this it is a general problem in user devices for wireless communication in radio networks to be able to use on-board power as efficiently as possible in order to increase battery time.

### SUMMARY

Embodiments of the present invention provide a solution which mitigates or solves the drawbacks and problems of conventional solutions.

The above aspects are solved by the subject matter of the independent claims. Further advantageous implementation forms of the embodiments of the present invention can be found in the dependent claims.

According to a first aspect of the invention, the above mentioned and other aspects are achieved with a user device for a wireless communication system, the user device comprising:

a processor, configured to

determine an on-duration period of an activity cycle,

check that a channel state information (CSI) is valid, and

monitor a down link control channel for down link control information only while the CSI is valid and the user device is in the on-duration period of the activity cycle.

When scheduling users in the radio network, it is beneficial to schedule users who have most up-to-date measured CSI available at the network side. An advantage of the solution according to the first aspect is that user devices having outdated CSI may be excluded from scheduling in the network, and thus if the CSI is no longer valid during the on-duration period the user device no longer has to monitor the down link control channel. On duration is thus adjusted based on user experienced channel coherence time. The user device may then save energy and wait for the next occasion for updating the CSI.

In a first possible implementation form of the user device according to the first aspect the processor is configured to enter the user device into a sleep mode when the CSI is invalid or the user device is outside the on-duration period of the activity cycle, i.e. in an inactivity period. Thus the processor is configured not to monitor the down link control channel when the CSI is invalid. An advantage is thus that the energy consumption of the user device may be drastically reduced, e.g. by entering a RF modem into a power saving sleep mode.

In a second possible implementation form of the user device according to any of the preceding possible implementation forms of the first aspect or to the first aspect as such the device comprises a receiver configured to receive an activity cycle on-duration configuration information from the wireless communication system and wherein the processor is configured to determine the on-duration period of the activity cycle from the activity cycle on-duration configuration information. An advantage is thus that the network knows when the user device is supposed to be monitoring the control channel. The activity cycle configuration information may include activity cycle start offset, inactivity timer and retransmission timer parameters. The activity cycle may be a Discontinuous Reception (DRX) cycle.

In a third possible implementation form of the user device according to any of the preceding possible implementation forms of the first aspect or to the first aspect as such, at least one CSI update, or more than one CSI update, is performed during the on-duration period. An advantage is thus that the validity of CSI may be maintained throughout the on-duration because of the one or more updates of the CSI during the on-duration period. An advantage of more than one CSI update is that, even if the validity of the CSI is shorter than the on-duration period, a valid CSI may be maintained during the on-duration period.

In a fourth possible implementation form of the user device according to any of the preceding possible implementation forms of the first aspect or to the first aspect as such the processor is configured to update the CSI by generating a CSI report and sending it from the user device to a network node. An advantage of CSI reporting is that hardware imperfections at the user devices may be taken into account without separate calibration and utilization of Frequency Domain Duplex (FDD). In Time Domain Duplex (TDD) the channel for down link transmissions may be measured from uplink pilot transmissions due to channel reciprocity.

In a fifth possible implementation form of the user device according to any of the preceding possible implementation forms of the first aspect or to the first aspect as such the processor is configured to update the CSI by sending a pilot signal from the user device to a network node. An advantage of the network measuring up link pilot signals sent by user devices is that by a single pilot transmission the channel may be estimated for all access node antenna elements simultaneously without sending down link pilots separately from all access node antenna elements. This has the advantage of reduced CSI delay and efficient spectrum usage. Hence, using TDD and measuring the channel from user transmitted pilot signals is considered increase channel estimation capacity of the network.

In a sixth possible implementation form of the user device according to any of the preceding possible implementation forms of the first aspect or to the first aspect as such the processor is configured to determine a threshold age value for the CSI and to determine that the CSI is valid when the time since the last CSI update is less than the threshold age value for the CSI. An advantage of monitoring CSI validity in massive MIMO systems is that it may prevent extra interference within the network of using old channel measurements for precoding.

According to a second aspect of the invention, the above mentioned and other objectives are achieved with network node for a radio network comprising:

a processor; and

a transceiver;

wherein the processor is configured to determine an on-duration period of an activity cycle,

wherein the transceiver is configured to receive a channel state information (CSI) update from a user device, and

wherein the processor further is configured to

check that the user CSI is valid, and

transmit data to the user device only while the user CSI is valid and the processor is in the on-duration period of the activity cycle.

An advantage is thus that the network node has information on when the user device is supposed to monitor the down link control channel, so that data is transmitted when the channel is monitored, thereby reducing transmission of unnecessary data.

According to a first possible implementation form of the second aspect the CSI update comprises a pilot signal from the user device, wherein the processor is configured to estimate the CSI based on the pilot signal, and wherein the transceiver is configured to transmit the estimated CSI to the user device. Thus the network node may estimate the CSI and report to the user device.

According to a second possible implementation form of the first implementation form of the second aspect or the second aspect as such, the transceiver is configured to receive channel state information (CSI) updates from the user device;

wherein the processor is configured to determine if the CSI updates of the user are not according to a CSI configuration, and then to update the CSI configuration of the user, and

wherein the transceiver is configured to transmit the updated CSI configuration to the user device.

An advantage is thus that the CSI configuration of the user device may be adjusted according to measurements performed in the network, e.g. the ageing of the CSI in relation to the periodicity of CSI updates.

According to a third possible implementation form of first or second possible implementation form of the second aspect, or the second aspect as such, the CSI configuration is a period of time between subsequent CSI updates.

According to a third aspect of the invention, the above mentioned and other objectives are achieved with a method for a user device, the method comprising:

determining an on-duration period of an activity cycle,

checking that a channel state information (CSI) is valid, and

monitoring a down link control channel for down link control information only while the CSI is valid and in the on-duration period of the activity cycle.

A first possible implementation form of the method according to the third aspect comprises entering into a sleep mode when the CSI is invalid or while not in the on-duration period.

A second possible implementation form of any preceding implementation forms of the method according to the third aspect or the method according to the third aspect as such comprises receiving an activity on-duration configuration information and determining the on-duration period of the activity cycle from the activity on-duration configuration information.

A third possible implementation form of any preceding implementation forms of the method according to the third aspect or the method according to the third aspect as such comprises performing at least one CSI update, or more than one CSI update, during the on-duration period.

A fourth possible implementation form of any preceding implementation forms of the method according to the third aspect or the method according to the third aspect as such comprises updating the CSI by generating a CSI report and sending it from the user device to a network node.

A fifth possible implementation form of any preceding implementation forms of the method according to the third aspect or the method according to the third aspect as such comprises updating the CSI by sending a pilot signal from the user device to a network node.

In a sixth possible implementation form of the fifth possible implementation form of the method according to the third aspect the method comprises determining a threshold age value for the CSI and determining that the CSI is valid when the time since the last CSI update is less than the threshold age value for the CSI.

According to a fourth aspect of the invention, the above mentioned and other objectives are achieved with a method for a network node, the method comprising:

determining an on-duration period of an activity cycle,

receiving channel state information (CSI) updates of a user,

checking that the user CSI is valid, and

transmitting data on a to the user only while the CSI is valid and while in the on-duration period of the activity cycle.

According to a first possible implementation form of the method according to the fourth aspect the CSI updates comprises a pilot signal from the user device, wherein the method comprises estimating the CSI based on the pilot signal, and transmitting the estimated CSI to the user device.

According to a second possible implementation form of the first implementation form of the fourth aspect or the fourth aspect as such, comprises receiving channel state information (CSI) updates from the user device;

determining if the CSI updates of the user are not according to a CSI configuration, and then to update the CSI configuration of the user, and

transmitting the updated CSI configuration to the user device.

According to a third possible implementation form of first or second possible implementation form of the fourth aspect, or the fourth aspect as such, the CSI configuration is a period of time between subsequent CSI updates.

The advantages of the methods according to the third aspect or the fourth aspect are the same as those for the corresponding device claims according to the first and second aspects.

The embodiments of the present invention also relates to a computer program, characterized in program code means, which when run by processing means causes said processing means to execute any method according to the embodiments of the present invention. Further, the embodiments of the invention also relates to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

An “or” in this description and the corresponding claims is to be understood as a mathematical OR which covers “and” and “or”, and is not to be understand as an XOR (exclusive OR).

Further applications and advantages of the embodiments of the present invention will be apparent from the following detailed description.

### BRIEF DESCRIPTION OF THE DRAWINGS

The appended drawings are intended to clarify and explain different embodiments of the present invention, in which:

FIG. 1 shows a user device and a network node according to embodiments of the invention;

FIG. 2 shows a method according to an embodiment of the invention;

FIG. 3 shows another method according to an embodiment of the invention;

FIG. 4 shows another method according to an embodiment of the invention;

FIG. 5 shows another method according to an embodiment of the invention;

FIG. 6 shows another method according to an embodiment of the invention;

FIG. 7 shows another method according to an embodiment of the invention;

FIG. 8 shows another method according to an embodiment of the invention;

FIG. 9 shows another method according to an embodiment of the invention.

### DETAILED DESCRIPTION

In FIG. 1, a user device 100 comprising a processor 102 and a transceiver 103 is shown in a radio network 101. The radio network comprises at least one network node 300 comprising a processor 302 and a transceiver 303.

The user device 100 discussed in the present disclosure may be any of a User Device (UD), User Equipment (UE), mobile station (MS), wireless terminal or mobile terminal which is enabled to communicate wirelessly in a wireless communication system, sometimes also referred to as a cellular radio system. The user device may further be referred to as mobile telephones, cellular telephones, computer tablets or laptops with wireless capability. The user devices in the present context may further be, for example, portable, pocket-storable, hand-held, computer-comprised, or vehicle-mounted mobile devices, enabled to communicate voice or data, via the radio access network, with another entity, such as another receiver or a server. The user device may be a Station (STA), which is any device that contains an IEEE 802.11-conformant Media Access Control (MAC) and Physical Layer (PHY) interface to the Wireless Medium (WM).

A network node in this disclosure may denote a (radio) network node or an access node or an access point or a base station, e.g., a Radio Base Station (RBS), which in some networks may be referred to as transmitter, “eNB”, “eNodeB”, “NodeB” or “B node”, depending on the technology and terminology used. The network nodes may be of different classes such as, e.g., macro eNodeB, home eNodeB or pico base station, based on transmission power and thereby also cell size. The network node may be a Station (STA), which is any device that contains an IEEE 802.11-conformant Media Access Control (MAC) and Physical Layer (PHY) interface to the Wireless Medium (WM).

A user device may follow an activity cycle wherein the user device may be in an on-duration of the activity cycle or in an inactive period of the activity cycle. Such activity cycles may be of different kinds, and one example is a Discontinous Reception (DRX) cycle. With Discontinuous Reception (DRX), as specified for LTE-A in 3GPP TS 36.321, the network may help user devices to save energy by estimating a suitable data burst inter-arrival time and assigning a DRX parameterization, and allocations according to that. The actual implementation allows the user device to not constantly monitor the downlink control channel every transmission time interval (TTI), but only during specific time interval set by higher layers. This solution provides benefits both in downlink and uplink because all the scheduling control information is transmitted on downlink control channel. The control channel carries downlink control information (DCI), which includes resource allocations for different types of data transmissions. During non active states, the user device can go into power saving states that dramatically decrease the power consumption impact of the RF modem. The radio resource control (RRC) protocol layer in LTE base station plays a crucial role in the DRX management, since it performs the biggest part of parameters setting for each user.

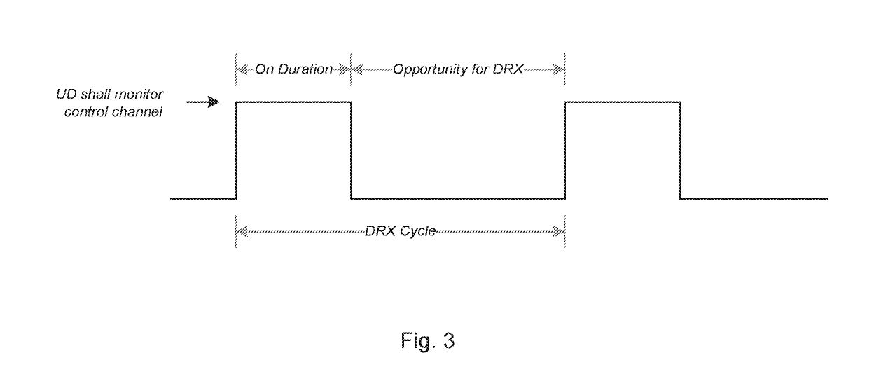

As shown in FIG. 3, a DRX cycle specifies the periodic repetition of the on-duration followed by a period of possible inactivity. For the on-duration the DRX timer specifies the number of consecutive subframes at the beginning of DRX cycle when the user device, UD, should monitor a control channel. In addition the user device has a DRX inactivity timer, which specifies the number of consecutive subframes after the subframe in which a control channel indicates an initial uplink/downlink (UL/DL) user data transmission for this user device. With the inactivity timer the on-duration is extended if there is data to be transmitted. In other words, the inactivity timer specifies how many subframes after successfully decoding a downlink control channel the user device should remain active. In any case the on-duration should be started again at the start of each DRX cycle.

In multi-user beam forming techniques including massive antenna arrays at the base station, channel coherence times are really short and there are not enough physical resources to do accurate measurements in a way that channel state information (CSI) is up-to-date all the time for every active user in a crowded network. Thus, when the CSI becomes outdated it would be beneficial to save energy in the user device e.g. by entering modem hardware into sleep mode until the next channel measurement takes place.

Therefore, the processor 102 of the user device 100 is configured to determine an on-duration period of an activity cycle, in this case a DRX cycle, to check that the CSI is valid and to monitor a down link control channel only while the CSI is valid and the user device is in the on-duration period of the DRX cycle.

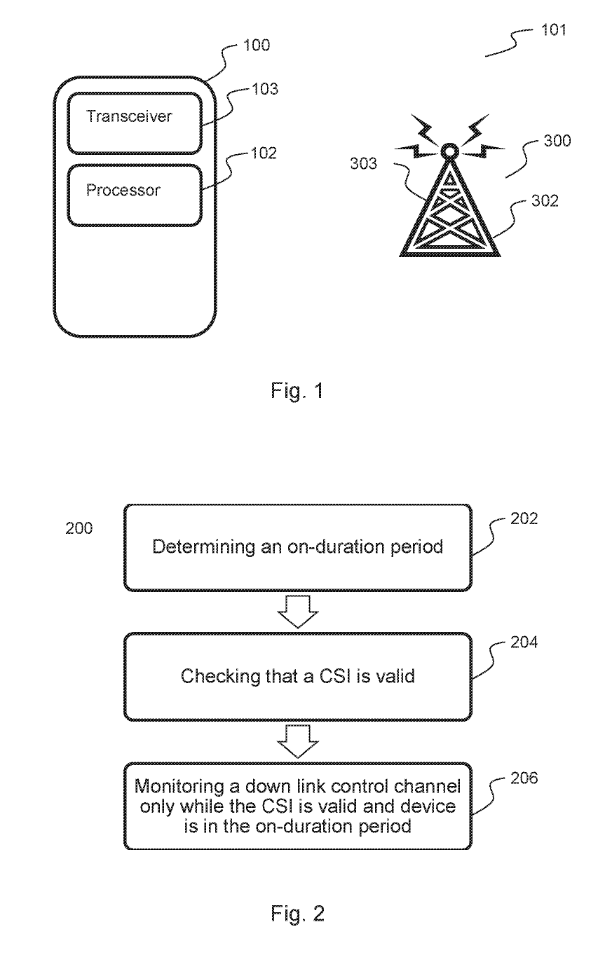

In FIG. 2, a method 200 for a user device is shown. The method comprises the steps of determining 202 an on-duration period of n activity cycle, checking 204 that the CSI is valid, and monitoring 206 a down link control channel only while the CSI is valid and the user device 100 is in the on-duration period of the activity cycle.

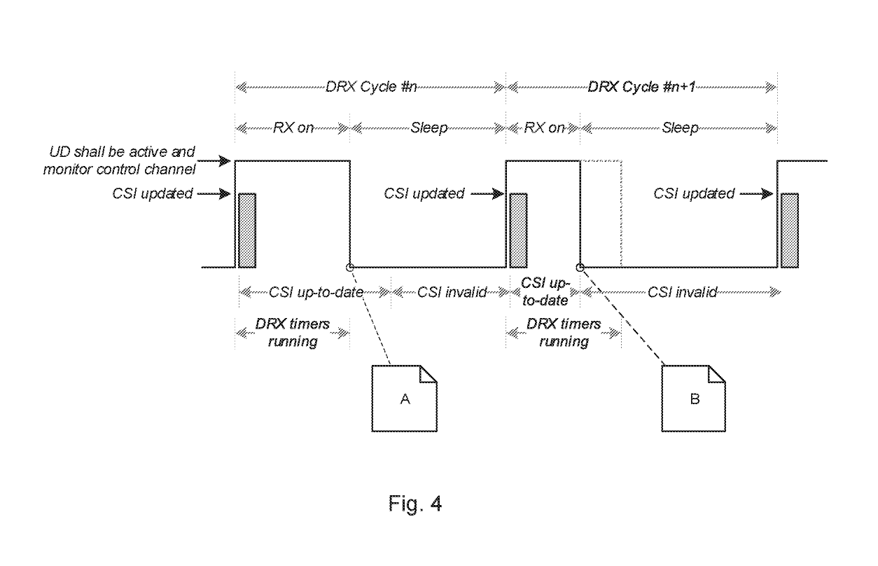

In FIG. 4, it is shown how the determination of the validity of the CSI may be used to regulate sleep in the user device, UD. The user device determines when CSI is up-to-date i.e. measures and estimates channel coherence times. When CSI is up-to-date and the DRX timer is in on-duration, the user device monitors a control channel. In the first DRX cycle (DRX cycle #n) the CSI is up to date during the complete on-duration of the DRX timer. Thus the user device goes to sleep when the DRX timer has expired, at (A). However, in the next DRX cycle (DRX cycle #n+1) CSI is out-dated before the expiry of the DRX timer. Therefore the user device enters into sleep when the CSI is no longer valid, at (B), and the user device may sleep until next CSI update in the subsequent DRX cycle.

DRX configuration may be given by network. DRX parameters may be sent to the user device through RRC signaling before the start of a DRX cycle. Hence, the user device has DRX parameters, which it uses to maintain the DRX timers. When the DRX timers expire, then user is not mandated to monitor the control channel as in LTE-A, and may thus save energy. If the CSI becomes out-dated before the DRX timers expire, then the user device may be released from its responsibility of being active and monitoring the control channel. If the user device goes to sleep because the CSI becomes out-dated, then the user device should wake up when next DRX cycle starts as illustrated in the FIG. 4 or when next CSI update takes place. In the example shown in FIG. 4 only a single CSI update is allocated to the user device during each DRX cycle.

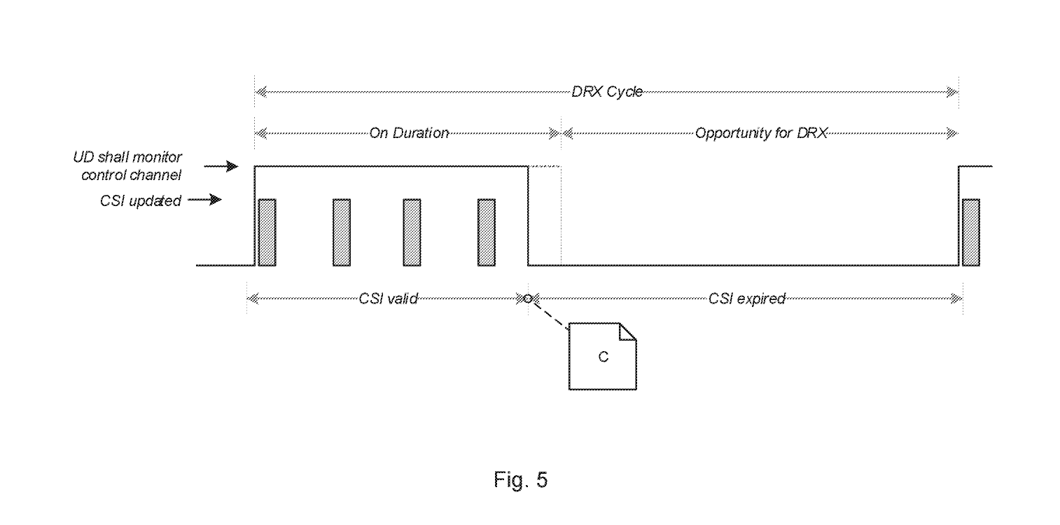

In FIG. 5, an example is shown where more than one CSI update (i.e. a plurality of CSI updates) is performed during a DRX cycle. In this case CSI is updated at four separate times during the DRX on-duration. After the initial CSI update, the following three CSI updates are performed while the preceding CSI is still valid, and thus the user device, UD, is configured to monitor the control channel during this period. However, the validity of the fourth CSI update expires before the expiry of the DRX on-duration period. This may be because channel coherence time has become shorter due to e.g. increase in the velocity of the user device. Hence, when this CSI is expired the user device is released from monitoring the control channel at (C), thus before the expiry of the DRX on-duration period. The user device may then enter in a sleep mode, e.g. by turning off parts of the transmitter or modem.

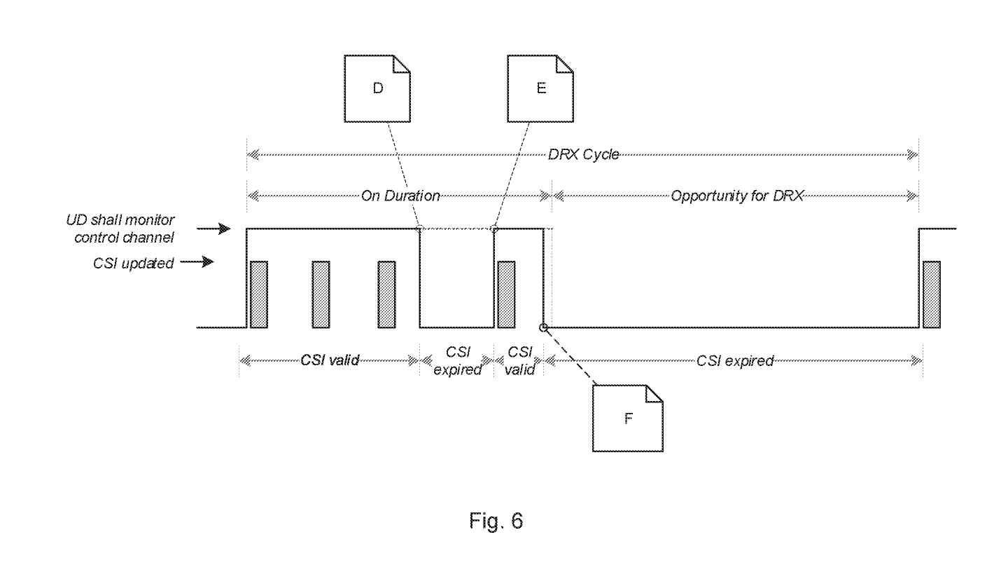

In FIG. 6, another example is shown where more than one CSI update (i.e. a plurality of CSI updates) is performed during a DRX cycle. In this example the CSI is updated at four separate times during the DRX on-duration. After the initial CSI update, the following two CSI update is performed while the preceding CSI is still valid, and thus the user device, UD, is configured to monitor the control channel during this period. However, the validity of the third CSI update expires before the expiry of the DRX on-duration period. This may happen e.g. if CSI periodicity, i.e. the time between subsequent CSI updates or the frequency of CSI updates, is not updated according to changed channel aging condition of the user device. Changes in channel aging condition may happen e.g. if the user velocity increases or e.g. line of sight signal is lost. Hence, when this CSI is expired the user device is released from monitoring the control channel at (D), thus before the expiry of the DRX on-duration period. At (E) a new fourth CSI update is performed and again the user device is configured to monitor the control channel until this CSI no longer valid, at (F), and the user device is again released from monitoring the control channel and may resume sleep mode.

The CSI update may be CSI a report sent by the user device or a pilot transmission sent by the user device and measured by the network. In case of a pilot transmission, the channel may be measured by a network node. In case of CSI report, the user device measures the channel and reports CSI back to the network.

Thus, knowledge about user experienced channel coherence time and thus CSI may be used to improve DRX. Channel coherence time is the time duration over which the radio channel is not varying significantly. User experienced channel coherence time may be defined in a way that when error rate of the downlink transmissions to the user is rising over a threshold, then it can be declared that limit for coherence has been reached. Coherence time limit Tₘₐₓ may be defined e.g. as described below. Thus, when maximum acceptable delay for CSI Tₘₐₓ is reached the user device should be considered to be at opportunity for DRX state until the CSI is updated. In following algorithm the time since the last beacon is used to determine the CSI age. This is the time lapsed from the time since last uplink pilot transmission (i.e. CSI beacon) to current time. The following algorithm is based on HARQ (Hybrid Automatic Repeat reQuest) feedback, which makes it possible to use the same algorithm in both network and user sides. This enables determining opportunity for DRX periods by both ends without extra signaling.

An underlying assumption is that channel aging together with short coherence times increases BLER (BLock Error Rate). The threshold age value for the CSI, i.e. the coherence time limit, may be determined using user reported HARQ feedback. Proposed algorithm follows same principles as well known OLLA (Outer Loop Link Adaptation) algorithm. Hence, if Positive Acknowledgement (ACK) is received, maximum acceptable delay Tₘₐₓ for Time Since Last Beacon (TSLB) may be increased by Tᵤₚ, while it is decreased by T_{down} if Negative Acknowledgement (NACK) is received. Hence, the ratio between Tᵤₚ and T_{down} is used to reach the wanted BLER_{target} with the following equation:

$${T}_{up} = \frac{{T}_{down}}{\frac{1}{{BLER}_{target}} - 1}$$

Therefore, each user fulfilling their individual coherence time criteria given as:

TSLBₙ<T_{max,n}

in the scheduling phase may be selected as a valid scheduling candidate. Parameters for Tᵤₚ/T_{down} calculation may be set by the network e.g. with Radio Resource Control (RRC) layer signaling.

The presented solution allows to optimize DRX reception in a way that the user device may save energy by stopping useless channel monitoring if the CSI is considered as outdated, and utilize that time for sleep e.g. by turning off at least some part of the modem. This is possible since it is beneficial to allocate CSI updating (by sending uplink pilot signals and/or CSI reports) semi-persistently to decrease unnecessary control signaling.

When the user device has periodical CSI updating, then it is possible to save energy by sleeping until the next CSI update occasion is scheduled to happen. Alternatively, if the CSI updates are not periodical, then the user device could hibernate and monitor only certain narrow band control channel resource element occasionally for a CSI update command.

For example, one possible solution for 5G high bandwidth frame structure is to have rather narrow center frequency, where users are monitoring a control channel and actual data transmissions are sent on wider frequency bands. Beacons are used as pilot signals sent by users. From said pilot signals, the network is able to measure the CSI with all its antenna elements. If a user CSI becomes outdated before the next CSI update, the user could monitor only certain defined parts of the center frequency control channel occasionally to get a new CSI beacon allocation. Monitoring only a small bandwidth occasionally saves energy significantly when compared to monitoring a high bandwidth.

The maximum acceptable delay for CSI, Tₘₐₓ, used for determining whether CSI is still valid or not, may be determined individually by the user device and the network node without extra signaling by utilizing HARQ feedback signaling. This may be achieved when both the user device and the network node calculate the maximum acceptable delay for CSI according to the desired BLER target as configured by the network. However, it is also possible that the network updates this CSI validity timer according to observed or estimated channel coherence. Whether the CSI validity timer is observed by the user device and network independently, or if network configures the CSI validity timer, it should be strictly specified when the user device should be monitoring the control channel and when it can expect that there won't be any information to it in control channel. Then user device may thus optimize its monitoring/sleep and the network knows when it may send control information to a certain user device. For example, in case of LTE-A, in 3GPP TS 36.321 control channel monitoring during DRX is specified for the user device according to parameters configured by the network.

As another example CSI configuration messages may be transmitted from the network to user device, e.g. to tune the CSI validity timer of the user device.

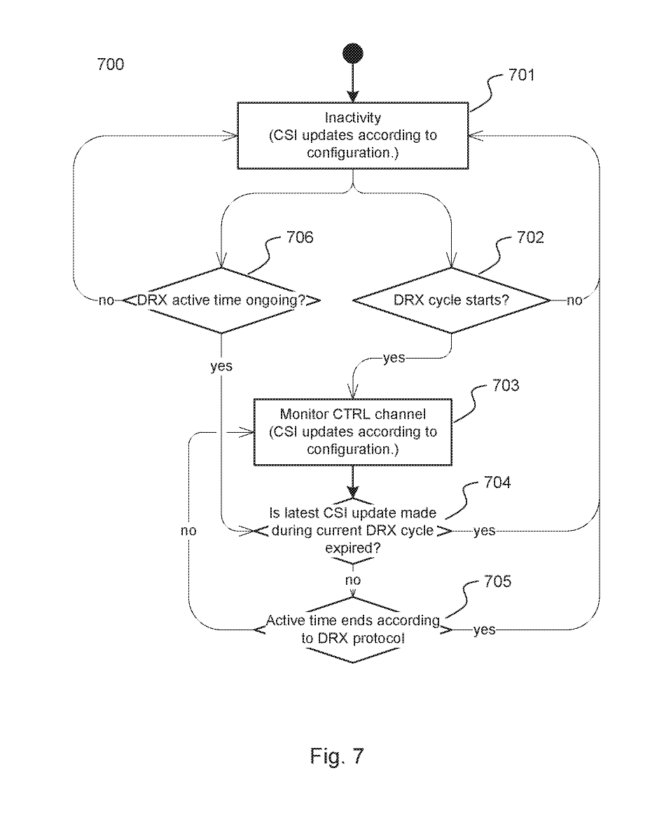

In FIG. 7, a method 700 of managing monitoring a down link control channel in a user device is shown. The basic principle is that if the user device is not scheduled to receive e.g. broadcasted data, it should not be required to monitor the control channel. Hence, when the CSI becomes out-dated, then the user device should start inactivity and stay inactive until the CSI is updated. When the user is inactive it should update the CSI before starting the DRX on-duration timer or at least at the beginning of the DRX on-duration.

Starting in 701 with user device inactivity (e.g. modem in inactive or sleep mode) the user device monitors if a DRX cycle stars, 702. If so, and CSI is valid, a down link control channel is monitored, 703. The validity of the latest CSI update is checked, 704. If the CSI has expired the device goes to inactivity, 701. Also if the CSI is valid but the DRX on-duration expires, 705, the device goes to inactivity and remains inactive 706 until the subsequent DRX cycle.

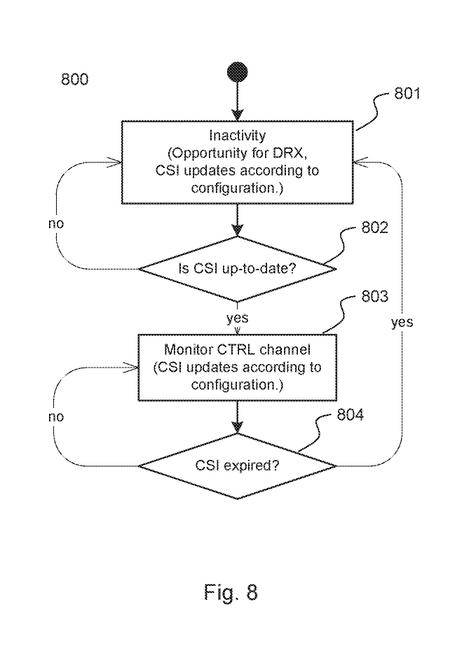

In FIG. 8, another method of managing monitoring a down link control channel in a user device is shown. The user device starts on-duration time, according to a DRX configuration, which is provided by the network. When in on-duration, the user device should monitor the control channel until on-duration ends according to the DRX configuration. It is assumed that at least one CSI update is made during each DRX cycle (preferably at the start of on-duration). If this CSI gets out-dated, then user device should go to inactivity state until the next DRX cycle starts. However, if a CSI update happens when the user device is in inactive state and the DRX on-duration is ongoing due to DRX configuration, then the user device is activated to monitor control channel until this latest CSI has expired or DRX on-duration ends due to DRX configuration.

Alternatively, the DRX may be dependent on the CSI updating cycle. Then the user device is monitoring dedicated control information from the down link control channel only when it has up-to-date CSI without a separate DRX configuration parameterization sent by the network. Then the DRX on-duration depend solely on individual CSI reporting or pilot transmission configuration chosen by the network for the user device. Dedicated control information is monitored only when CSI is up-to-date. If CSI becomes out-dated, then the user device is able to save energy by being inactive until CSI is updated.

In FIG. 8, the user device should enter into active state when the CSI is updated according to a CSI report or pilot transmission configuration. Then the user device should monitor the control channel in its active state until CSI is expired. This would enable inactivity periods for active users without DRX configuration if the network cannot provide enough resources for CSI updates according to requirement set by experienced channel aging. Then the user device should start monitoring the control channel once the CSI is updated and monitor as long as the CSI is valid. During the active period the CSI might be updated periodically or aperiodically, but once the CSI is considered to be expired and the user device has the next CSI update configured, then the user device is allowed be inactive until the next scheduled CSI update. In this embodiment the user device has to know its next CSI update occasion before inactivity may be initiated. The network thus has to schedule the next CSI update in advance to enable the user device's sleep or allocation for periodical CSI updates needs to be given for the user device in other ways.

The user device may still be mandated to receive some broadcasted network specific RRC control data or other mandatory broadcasted information (like Earthquake and Tsunami Warning System (ETWS) messages) on certain time/frequency slots, even when CSI is outdated. However, for dedicated data transmissions in cells or networks where multi-user beamforming is utilized, the user device may omit control channel monitoring for dedicated data transmission allocations when the CSI is considered to be out-dated.

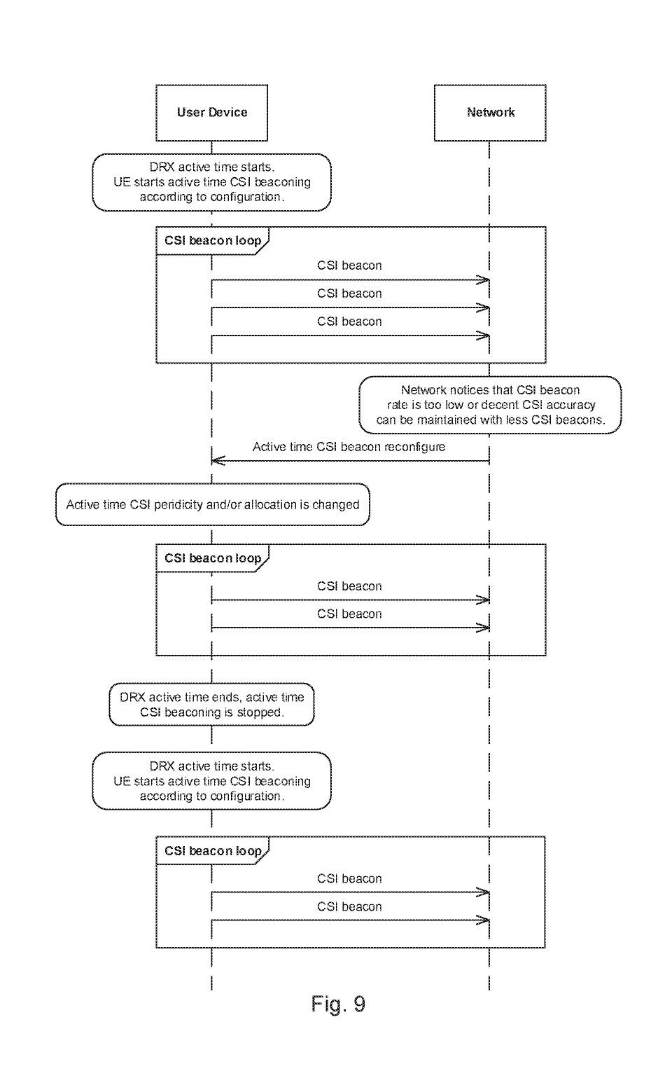

FIG. 9 shows a method wherein the network node may configure the user device to update its CSI during the on-duration (e.g. by sending CSI beacons or reports) in a way that CSI will not become out-dated during the desired on-duration time. In other words, the network node may set the required CSI update periodicity dynamically so that during on-duration CSI updates are chosen to maintain the desired BLER level in data transmissions. Thus the CSI may be maintained valid. The user device has a configuration for CSI beaconing during on-duration. If the network node notices that the user device's CSI aging is not in line with a CSI update configuration, then the network node may change the CSI beaconing allocation and/or periodicity. When the active period ends due to DRX timers, then the user device should stop CSI beaconing. If the active period was ended due to CSI expiration, then the user device should start active time when the next CSI beacon transmission is triggered according to active time CSI beaconing configuration.

What is claimed is:

1. A user device for a wireless communication system, the user device comprising:
a memory to store instructions; and
a processor to execute the instructions to configure the processor to:
determine an on-duration period of an activity cycle;
determine whether a channel state information (CSI) is valid; and
monitor a down link control channel for down link control information only while the CSI is valid and the user device is in the on-duration period of the activity cycle.

2. The user device according to claim 1, wherein the processor is configured to enter the user device into a sleep mode when the CSI is invalid or when the user device is outside of the on-duration period of the activity cycle.

3. The user device according to claim 1, further comprising a receiver configured to receive an activity cycle on-duration configuration information from the wireless communication system, and wherein the processor is further configured to determine the on-duration period of the activity cycle from the activity cycle on-duration configuration information.

4. The user device according to claim 1, wherein at least one CSI update is performed during the on-duration period.

5. The user device according to claim 1, wherein the processor is configured to update the CSI by generating a CSI report and sending the CSI report from the user device to a network node.

6. The user device according to claim 1, wherein the processor is configured to update the CSI by sending a pilot signal from the user device to a network node.

7. The user device according to claim 1, wherein the processor is further configured to determine a threshold age value for the CSI and to determine that the CSI is valid when the time since the last CSI update is less than the threshold age value for the CSI.

8. A network node for a wireless communication system comprising:
a transceiver configured to receive a channel state information (CSI) update from a user device; and
a processor configured to:
determine an on-duration period of an activity cycle,
check whether the user CSI is valid, and
transmit data to the user device only while the user CSI is valid and the activity cycle is in the on-duration period.

9. The network node according to claim 8, wherein the CSI update comprises a pilot signal from the user device, wherein the processor is further configured to estimate the CSI based on the pilot signal, and wherein the transceiver is further configured to transmit the estimated CSI to the user device.

10. The network node according to claim 8 wherein
the transceiver is further configured to receive channel state information (CSI) updates from the user device;
the processor is further configured to determine when the CSI updates of the user are not according to a CSI configuration, and then to update the CSI configuration of the user, and
the transceiver is further configured to transmit the updated CSI configuration to the user device.

11. The network node according to claim 10 wherein the CSI configuration includes a period of time between subsequent CSI updates.

12. A method for a user device, the method comprising:
determining an on-duration period of an activity cycle;
determining whether a channel state information (CSI) is valid; and
monitoring a down link control channel for down link control information only while the CSI is valid and the user device is in the on-duration period of the activity cycle.

13. A non-transitory computer-readable medium storing instructions which, when executed by a computer, cause the computer to execute a method for a user device comprising:
determining an on-duration period of an activity cycle;
determining whether a channel state information (CSI) is valid; and
monitoring a down link control channel for down link control information only while the CSI is valid and the user device is in the on-duration period of the activity cycle.

14. The non-transitory computer-readable medium of claim 13, wherein the method further comprising:
entering the user device into a sleep mode when the CSI is invalid or when the user device is outside of the on-duration period of the activity cycle.

15. The non-transitory computer-readable medium of claim 13, wherein the method further comprising:
receiving, by a receiver of the user device, an activity cycle on-duration configuration information from the wireless communication system, and
determining the on-duration period of the activity cycle from the activity cycle on-duration configuration information.

16. The non-transitory computer-readable medium of claim 13, wherein the at least one CSI update is performed during the on-duration period.

17. The non-transitory computer-readable medium of claim 13, wherein the method further comprising:
updating the CSI by generating a CSI report and sending the CSI report from the user device to a network node.

19. The non-transitory computer-readable medium of claim 13, wherein the method further comprising:
updating the CSI by sending a pilot signal from the user device to a network node.

20. The non-transitory computer-readable medium of claim 13, wherein the method further comprising:
determining a threshold age value for the CSI and to determine that the CSI is valid when the time since the last CSI update is less than the threshold age value for the CSI.
